(19) United States
(12) Patent Application Publication
(10) Pub. No.: US 2026/0313543 A1
(43) Pub. Date: Oct. 8, 2026

(54) TCI STATE AND LP-WUS RESOURCES

(71) Applicant: QUALCOMM Incorporated, San Diego, CA (US)

(72) Inventors: Jung Ho RYU, Englewood Cliffs, NJ (US); Igor GUTMAN, Hod Hasharon (IL); Jelena DAMNJANOVIC, Del Mar, CA (US)

(21) Appl. No.: 19/169,819

(22) Filed: Apr. 3, 2025

(51) Int. Cl. H04W 52/02; H04B 7/06; H04W 76/20

(52) U.S. Cl. CPC H04W 52/0229; H04B 7/06968; H04W 76/20

(57) ABSTRACT

Apparatus, methods, and computer program products for wireless communication are provided. An example method may include monitoring for a low-power wake up signal (LP-WUS) based on a set of inactivated transmission configuration indicator (TCI) states. The example method may further include receiving, from a network node, the LP-WUS associated with a TCI state of the set of inactivated TCI states. The example method may further include transmitting, to the network node, an indication of the TCI state of the set of inactivated TCI states.

### TECHNICAL FIELD

The present disclosure relates generally to communication systems, and more particularly, to wireless communication systems with low-power wake up signal (LP-WUS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) monitor for a low-power wake up signal (LP-WUS) based on a set of inactivated transmission configuration indicator (TCI) states. Based at least in part on information stored in the at least one memory, the at least one processor, individually or in any combination, is configured to receive, from a network node, the LP-WUS associated with a TCI state of the set of inactivated TCI states. Based at least in part on information stored in the at least one memory, the at least one processor, individually or in any combination, is configured to transmit, to the network node, an indication of the TCI state of the set of inactivated TCI states.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a group of UEs, a set of LP-WUSs based on a set of TCI states, where each LP-WUS of the set of LP-WUSs is mapped to a corresponding TCI state of the set of TCI states. Based at least in part on information stored in the at least one memory, the at least one processor, individually or in any combination, is configured to receive, from one UE of the group of UEs, an indication of one TCI state of the set of TCI states.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example low power wake up radio (LP-WUR) device, in accordance with various aspects of the present disclosure.

FIG. 5 is a diagram illustrating a network node in communication with a UE via a set of beams, in accordance with various aspects of the present disclosure.

FIG. 6 is a diagram illustrating example on-off keying (OOK) waveforms for low power wake up signal (LP-WUS), in accordance with various aspects of the present disclosure.

FIG. 7 is a diagram illustrating example connected mode discontinuous reception (DRX) (C-DRX), in accordance with various aspects of the present disclosure.

FIG. 8 is a diagram illustrating example monitoring triggered by LP-WUS with C-DRX configuration, in accordance with various aspects of the present disclosure.

FIG. 9 is a diagram illustrating an example UE that may be out of range for LP-WUS but in range for physical downlink control channel (PDCCH), in accordance with various aspects of the present disclosure.

FIG. 10 is a diagram illustrating an example where UEs are grouped into two groups based on associated downlink beam(s), in accordance with various aspects of the present disclosure.

FIG. 11 is a diagram illustrating example communications between a UE and a network node, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a diagram illustrating an example of a hardware implementation for an example apparatus and/or network entity.

FIG. 15 is a flowchart of a method of wireless communication, in accordance with various aspects of the present disclosure.

FIG. 16 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Example aspects provided herein enables a user equipment (UE) to check whether the UE is in the range of a low-power wake up signal (LP-WUS) associated with the network by associating different time/frequency resources for LP-WUS based on downlink (DL) beams. Example aspects may enable a UE to determine a suitable downlink beam associated with the UE based on monitoring of a LP-WUS, which may improve communication performance.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

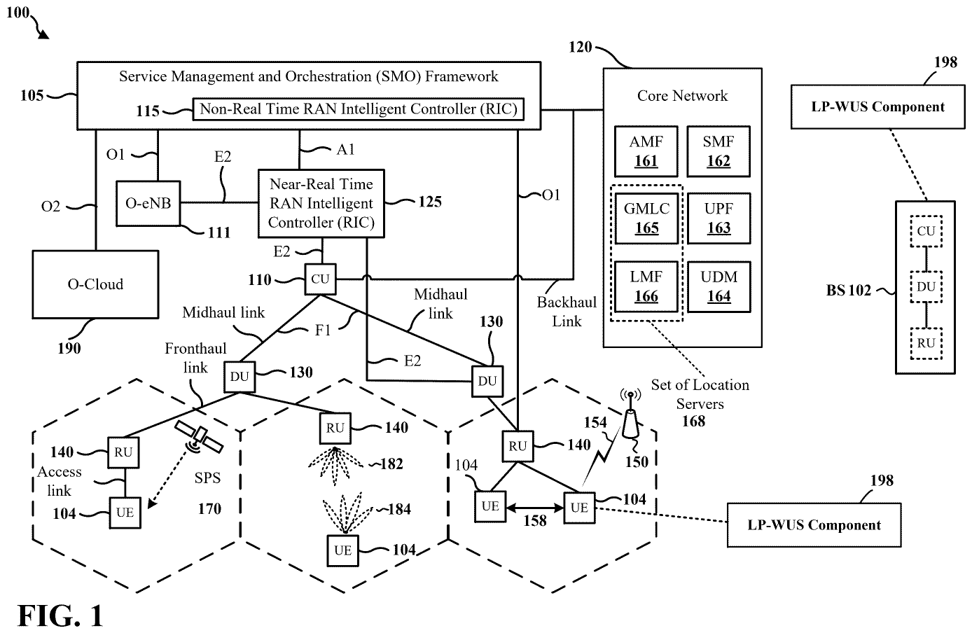

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a LP-WUS component 198. In some aspects, the LP-WUS component 198 may be configured to monitor for a LP-WUS based on a set of inactivated transmission configuration indicator (TCI) states. In some aspects, the LP-WUS component 198 may be further configured to receive, from a network node, the LP-WUS associated with a TCI state of the set of inactivated TCI states. In some aspects, the LP-WUS component 198 may be further configured to transmit, to the network node, an indication of the TCI state of the set of inactivated TCI states.

In certain aspects, the base station 102 may include a LP-WUS component 199. In some aspects, the LP-WUS component 199 may be configured to transmit, for a group of UEs, a set of LP-WUSs based on a set of TCI states, where each LP-WUS of the set of LP-WUSs is mapped to a corresponding TCI state of the set of TCI states. In some aspects, the LP-WUS component 199 may be further configured to receive, from one UE of the group of UEs, an indication of one TCI state of the set of TCI states.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

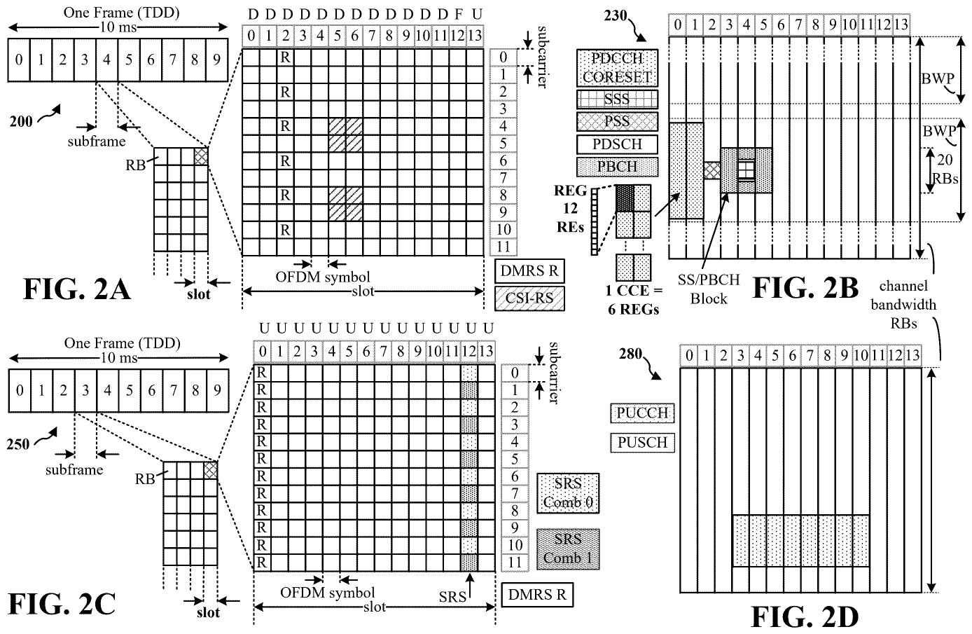

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

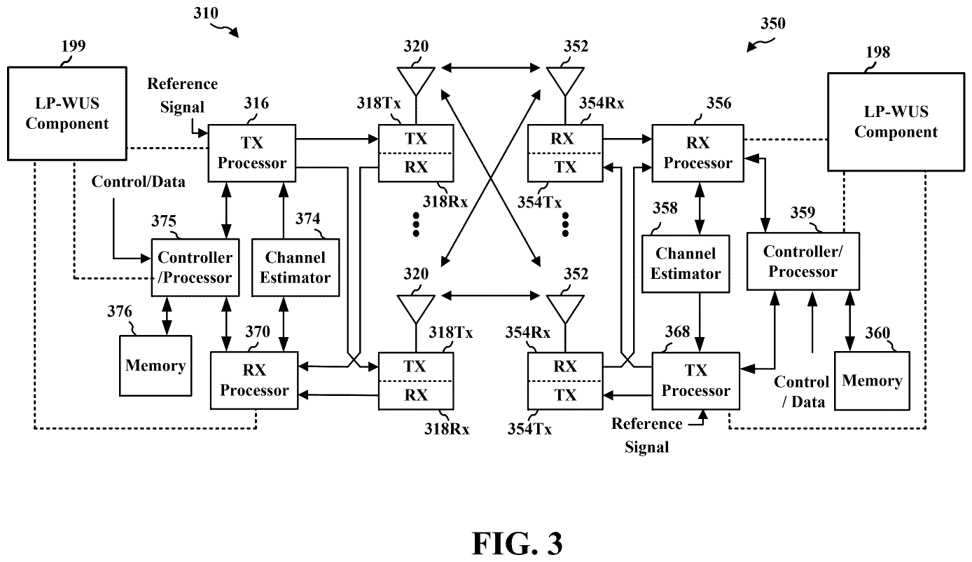

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with LP-WUS component 198 of FIG. 1.

At least one of the TX processor 316, the RX processor 370, and the controller/processor 375 may be configured to perform aspects in connection with LP-WUS component 199 of FIG. 1.

Backscatter communication may enable radio frequency identification (RFID). For example, a reader may send a continuous waveform signal and interrogate commands. An RF tag (which is a passive wireless device) may harvest energy from the continuous waveform signal and may respond to the interrogation by varying its input impedance (e.g., between conjugate match and strongly mismatched), therefore modulating the backscattered signals.

In some wireless communication systems, passive wireless devices such as zero-power passive IoT wireless devices may be included. Such passive wireless devices may be without active RF components and may perform transmissions based on backscatter communication and may perform reception based on envelope detection or an envelope detector. Backscatter communication may modulate information on an incoming RF signal (which may be a carrier wave that may carry communication between other devices) by an adaptation of antenna load impedance. A passive wireless device may be battery-less or battery assisted. For example, a passive wireless device may operate based on energy harvesting from an incoming radio wave with or without a battery as an additional power source. A passive wireless device may have low power consumption, such as between 1 microwatt to 1000 microwatts. Such passive wireless devices may be devices for inventory management, wireless sensors, or the like.

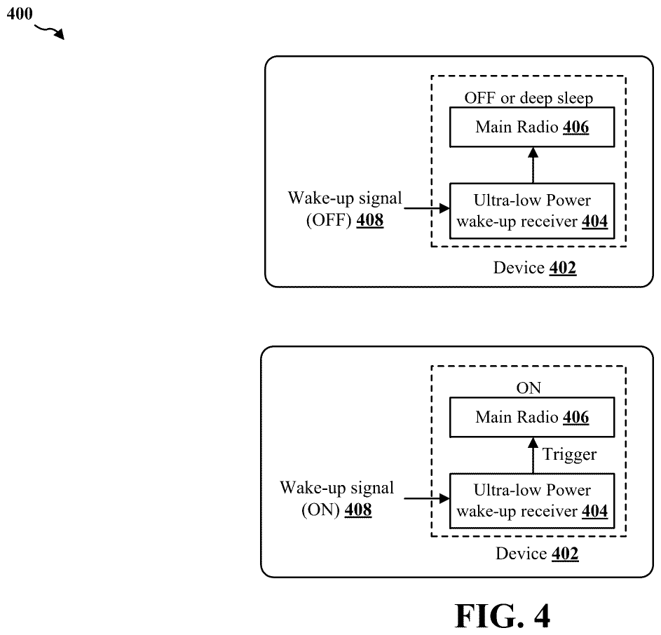

Wireless devices, e.g., which may include the passive wireless device, may use a LP-WUR. In some aspects, a UE may include a LP-WUR. A LP-WUR may be a radio receiver circuit (and may be an envelope detector) with a low energy consumption. FIG. 4 is a diagram 400 illustrating example device 402 (such as an active UE) with a LP-WUR. The active UE may use LP-WUR to dynamically activate main radio 406 for reducing power consumption. When there is no data to receive, main radio 406 may be off unless there is something to transmit. The LP-WUR may keep actively monitoring the WUS 408 with low power. When there is data to receive, the LP-WUR may receive on-demand the WUS 408 via the ultra-low power wake up receiver 404 and activate a main radio 406. Data may be transmitted and received by the main radio 406. Such a LP-WUR may enable frequent WUS monitoring to meet a latency specification and may present low energy consumption compared to some of duty-cycling schemes. Such a WUR may also avoid excessive unnecessary main radio wakeup for PDCCH monitoring. The term “WUS” may refer to a signal used for waking up a passive wireless device (e.g., so that it may perform transmissions).

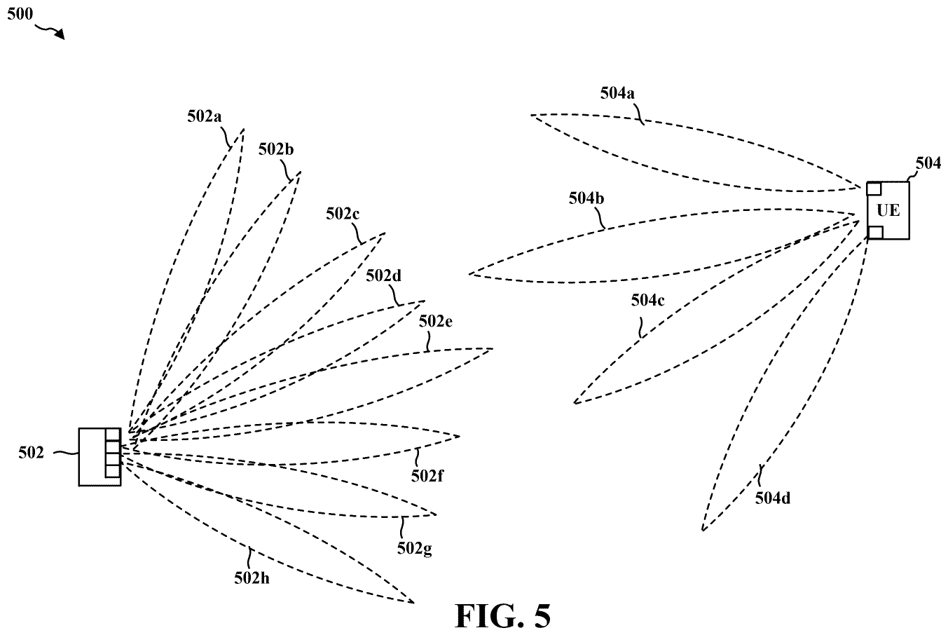

FIG. 5 is a diagram 500 illustrating a network node 502 in communication with a UE 504. Referring to FIG. 5, the network node 502 may transmit a beamformed signal to the UE 504 in one or more of the directions 502a, 502b, 502c, 502d, 502e, 502f, 502g, 502h. The UE 504 may receive the beamformed signal from the network node 502 in one or more receive directions 504a, 504b, 504c, 504d. The UE 504 may also transmit a beamformed signal to the network node 502 in one or more of the directions 504a-404d. The network node 502 may receive the beamformed signal from the UE 504 in one or more of the receive directions 502a-402h. The network node 502/UE 504 may perform beam training to determine the best receive and transmit directions for each of the network node 502/UE 504. The transmit and receive directions for the network node 502 may or may not be the same. The transmit and receive directions for the UE 504 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 504 may determine to switch beams, e.g., between beams 502a-502h. The beam at the UE 504 may be used for reception of downlink communication and/or transmission of uplink communication. In some examples, the network node 502 may send a transmission that triggers a beam switch by the UE 504. A TCI state may include quasi co-location (QCL) information that the UE can use to derive timing/frequency error and/or transmission/reception spatial filtering for transmitting/receiving a signal. Two antenna ports are said to be quasi co-located (e.g. QCLed) if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports, information that the UE can use to derive timing/frequency error and/or transmission/reception spatial filtering for transmitting/receiving a signal PDSCH/PDCCH DM-RS from transmitting/receiving the DL RSs. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. QCL relationships may be specified in terms of QCL types. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). TCI states can provide information about different beam selections for the UE to use for transmitting/receiving various signals. For example, the network node 502 may indicate a TCI state change, and in response, the UE 504 may switch to a new beam or spatial filter (e.g., a beam may correspond to a spatial filter) according to the new TCI state indicated by the network node 502.

In some wireless communication systems, such as a wireless communication system under a unified TCI framework, a pool of joint DL/UL TCI states may be used for joint DL/UL TCI state updates for beam indication. For example, the network node 502 may transmit a pool of joint DL/UL TCI states to the UE 504. The UE 504 may determine to switch transmission beams and/or reception beams based on the joint DL/UL TCI states. In some aspects, the TCI state pool for separate DL and UL TCI state updates may be used. In some aspects, the network node 502 may use RRC signaling to configure the TCI state pool. In some aspects, the joint TCI may or may not include UL-specific parameter(s) such as UL PC/timing parameters, PL RS, panel-related indication, or the like. If the joint TCI includes the UL-specific parameter(s), the parameters may be used for the DL reception or UL transmissions to which the joint TCI is applied.

An LP-WUS may be used in connection with connected mode discontinuous reception (DRX) (C-DRX) for trigger of PDCCH monitoring as a power saving procedure for RRC connected mode. For LP-WUS, the UE may be equipped with LP-WUR that may be switched on and off quickly and capable of receiving and processing simple signals (e.g., small bandwidth and simpler waveform). The LP-WUR may use less power to operate than main radio (MR) and may not be able to transmit. The UE may be able to switch off MR to save power. With MR off, UE uses LP-WUR to monitor for LP-WUS; if network transmits LP-WUS and UE receive LP-WUS, the UE wakes up (switches on) its MR and receive control message from network (LP-WUS triggered PDCCH monitoring) using MR.

C-DRX is a UE power saving procedure in which UE periodically wakes up to monitor PDCCH for control message from network. The periods when UE wakes up to monitor PDCCH for control message from network may be called C-DRX active time or a DRX ON duration. When UE is not in active time (i.e., monitoring PDCCH), UE is allowed to go into sleep, e.g., and may be referred to as a C-DRX inactive time or a DRX OFF duration. For C-DRX without LP-WUS, when the UE it is not a DRX active time for the UE, the network may not be able to transmit control signaling to the UE (e.g., as the UE is not monitoring for control signaling), which may increase latency.

PDCCH monitoring triggered by LP-WUS with C-DRX configuration may be based on LP-WUS monitoring according to the LP-WUS monitoring configuration before a DRX duration timer (e.g., represented by information element (IE) drx-onDurationTimer) to trigger the starting of the DRX duration timer. PDCCH monitoring triggered by LP-WUS with C-DRX configuration may also be based on LP-WUS monitoring outside at least C-DRX active time according to the LP-WUS monitoring configuration (e.g., in configured LP-WUS monitoring occasion) to trigger PDCCH monitoring. PDCCH monitoring triggered by LP-WUS with C-DRX configuration may also be based on LP-WUS monitoring inside the legacy C-DRX active time according to the LP-WUS monitoring configuration to trigger PDCCH monitoring.

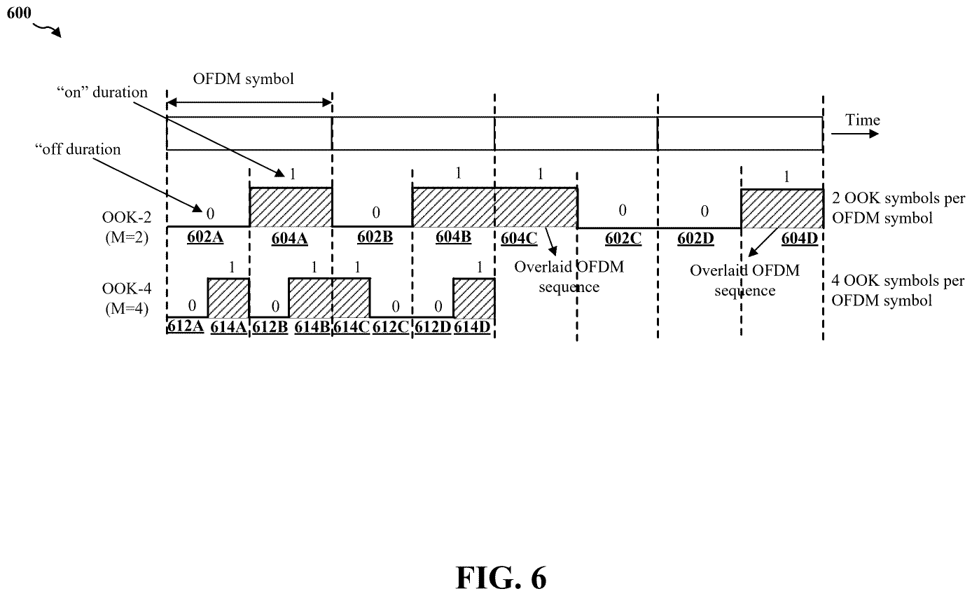

FIG. 6 is a diagram 600 illustrating example on-off keying (OOK) waveforms, e.g., aspects of which may be used for LP-WUS, in accordance with various aspects of the present disclosure. OOK waveform is a sequence of high power/amplitude (or ON) durations or low (or zero) power/amplitude (or OFF) durations. As illustrated in FIG. 6, for an example OOK-4 waveform with two OOK symbols per OFDM symbol, there may be a first OFF duration 602A, a second OFF duration 602B, a third OFF duration 602C, a fourth OFF duration 602D, a first ON duration 604A, a second ON duration 604B, a third ON duration 604C, and a fourth ON duration 604D. For an example OOK-4 waveform with four OOK symbols per OFDM symbol, there may be a first OFF duration 612A, a second OFF duration 612B, a third OFF duration 612C, a fourth OFF duration 612D, a first ON duration 614A, a second ON duration 614B, a third ON duration 614C, and a fourth ON duration 614D. A waveform of OOK-4 with parameter M conveys M bits of information in 1 OFDM symbol. A overlaid OFDM sequence may be Gold sequence, M sequence, computer searched sequence, or Zadoff Chu sequence. A high/low duration may be used to convey an information bit.

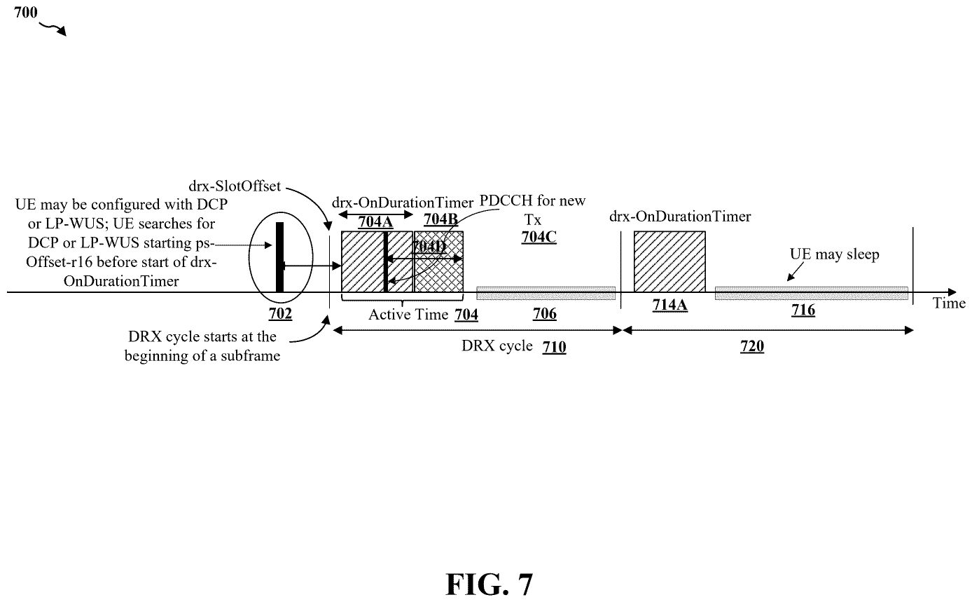

FIG. 7 is a diagram 700 illustrating example connected mode discontinuous reception (DRX) (C-DRX), in accordance with various aspects of the present disclosure. At 702, the UE may be configured with a DCP and the UE may search for DCP starting offset (e.g., IE ps-Offset-r16) before a start of the DRX ON duration timer (IE drx-OnDurationTimer). After the start of the DRX ON duration, the UE may monitor for a PDCCH based on the DRX ON duration timer 704A. Based on detecting a PDCCH 704C, the UE may extend the active time 704 so that the UE may remain active during a duration 704B (e.g., based on IE drx-InactivityTimer 704D). The UE may enter sleep mode during a remainder 706 of the DRX cycle 710. In a second DRX cycle 720, the UE may monitor for a PDCCH based on the DRX ON duration timer 714A. The UE may not detect any PDCCH and may enter sleep at 716 after the DRX ON duration timer 714A expires. In other words, the UE monitors PDCCH on the serving cell during active time. The active time includes time while drx-onDurationTimer or drx-InactivityTimer configured for the DRX group is running. If the UE receives a PDCCH that indicates a new transmission (DL, UL or SL) on a serving cell in this DRX group, the UE may start or restart drx-InactivityTimer. The starting subframe of DRX cycle may be determined based on configuration parameter drx-LongCycleStartOffset. The DCP may be a wake up signal transmitted in DCI received via MR. The parameter ps-Offset-r16 is the start of the search-time of DCI format 2-6 with CRC scrambled by PS-RNTI relative to the start of the drx-onDurationTimer of Long DRX.

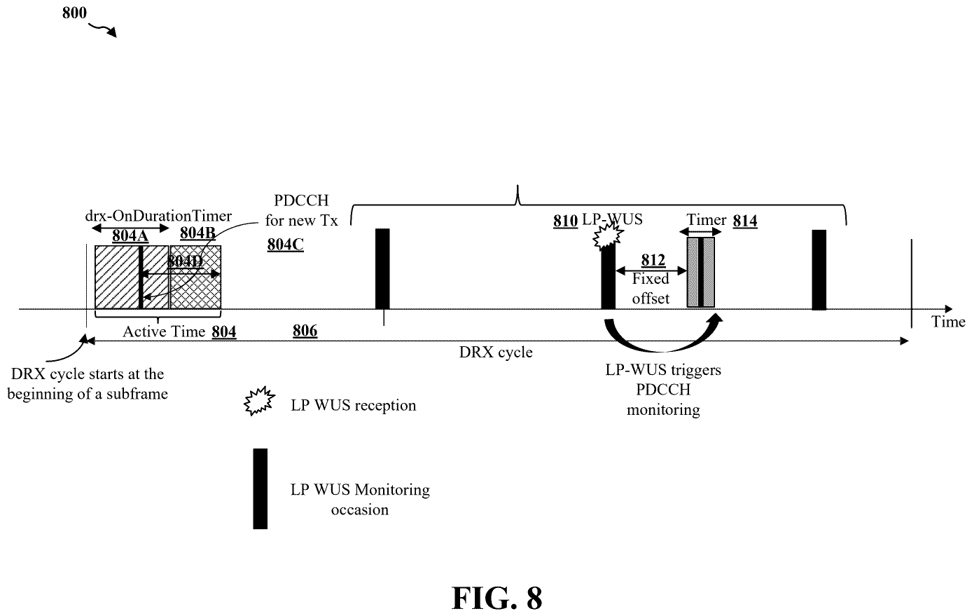

FIG. 8 is a diagram 800 illustrating example monitoring triggered by LP-WUS with C-DRX configuration, in accordance with various aspects of the present disclosure. As illustrated in FIG. 8, the DRX starts at the beginning of a subframe and the UE may monitor for a PDCCH based on the DRX ON duration timer 804A. Based on detecting a PDCCH 804C, the UE may extend the active time 804 so that the UE may remain active during a duration 804B (e.g., based on IE drx-InactivityTimer 804D). The UE may enter sleep mode during a remainder 806 of the DRX cycle 810. In a second DRX cycle, the UE may monitor for a LP-WUS in the LP-WUS monitoring occasions configured in a LP-WUS configuration, which are outside the active time based on the C-DRX configuration. At 810, the UE may be able to detect a LP-WUS which triggers PDCCH monitoring after a fixed offset 812. The UE may monitor for a PDCCH until a timer 814 expires.

Target coverage range of LP-WUS (DL signal) may be similar to a target range of message 3 (UL signal) and the LP-WUS target range may be smaller than PDCCH range because the LP-WUS uses OOK waveform where as PDCCH uses OFDM waveform. Therefore, in some wireless communication systems, if a UE moves out of LP-WUS range, then network and UE may not rely on LP-WUS to trigger PDCCH monitoring. The UE may be able to detect that it is out of LP-WUS range based on reception of periodic signal, which could be LP-WUS (e.g., if UE receives the signal, then it is in range; if not, it is not in range) or any signal that is based on OOK waveform.

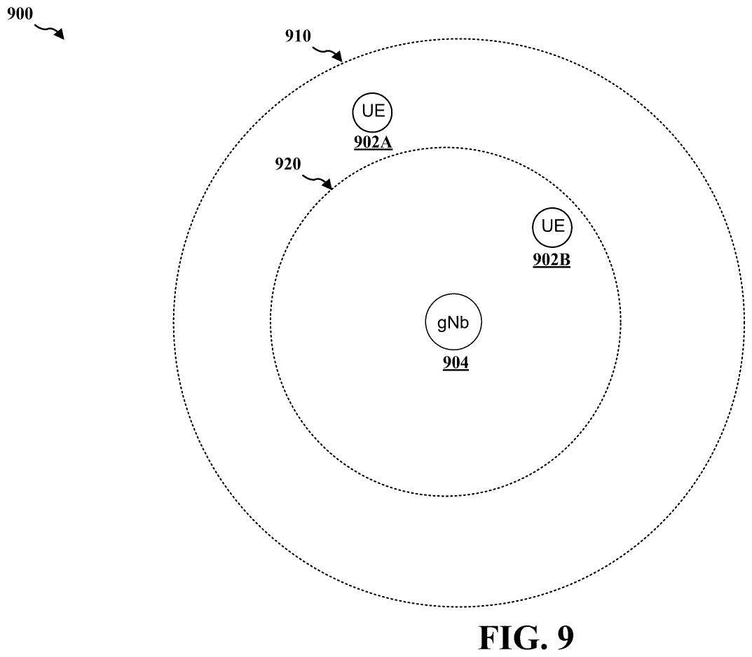

FIG. 9 is a diagram 900 illustrating an example UE 902A that may be out of range for LP-WUS but in range for PDCCH, in accordance with various aspects of the present disclosure. As illustrated in FIG. 9, the PDCCH may be associated with a first range 910 and the LP-WUS may be associated with a second range 920. For a UE 902B in communication with a network node 904, it may be in range of both PDCCH and LP-WUS. However, for a UE 902A in communication with a network node 904, it may be in range of PDCCH but out of range for LP-WUS.

UEs that may be receiving LP-WUS on the same DL Tx beam may use the set of same time and frequency resources for LP-WUS (e.g., an association between each DL beam and a set of respective time and frequency resources for LP-WUS associated with the DL beam) so that LP-WUS may be used as a way for UEs to determine whether they are in LP-WUS range. For example, there may be a blank LP-WUS (with no target UE) that the network transmits so that UE(s) may use the blank LP-WUS to check the range (if UE receives it, then it is in range), or LP-WUS targeted for one UE that may be used by other UEs as a way to check range (target UE and other UEs are on the same DL Tx beam). In addition, a configured association between each DL beam and a set of respective time and frequency resources for LP-WUS associated with the DL beam may facilitate a low amount of resource usage for LP-WUS compared to using resources dedicated for each UE.

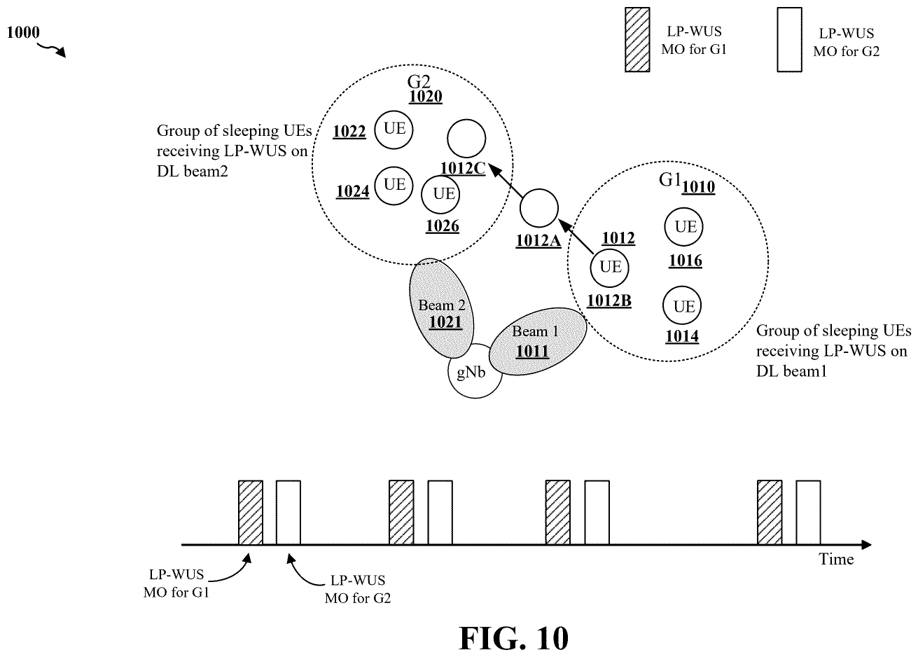

FIG. 10 is a diagram 1000 illustrating an example where UEs are grouped into two groups based on associated downlink beam(s), in accordance with various aspects of the present disclosure. In the example illustrated in FIG. 10, there may be two groups of UEs, a first group 1010 which includes UE 1012, UE 1014, and UE 1016, and a second group 1020 which includes UE 1022, UE 1024, and UE 1026. The first group 1010 may be reached based on a first DL beam 1011 and the second group 1020 may be reached based on a second DL beam 1021. In some wireless communication systems, the UEs are not assigned LP-WUS resources based on DL beam. If the network node transmit LP-WUS to UE 1022, UE 1012, and UE 1014 in dedicated time and frequency resources for each UE and the UEs 1022, 1012 1014 are not aware of other UEs dedicated resources, the UEs may not be able to use that LP-WUS transmission to check if they are in range. For example, unless the network allocates additional resources for a beam based broadcast signal specifically for UEs to use to check the LP-WUS range, UEs may not have a way to check the range, which may be inefficient. Example aspects provided herein enables a UE to check whether it's in the range of a LP-WUS associated with the network by associating different time/frequency resources for LP-WUS based on DL beam. Example aspects may enable a UE to determine a suitable downlink beam associated with the UE based on monitoring of a LP-WUS, which may improve communication performance.

In some aspects, UEs are assigned/allocated LP-WUS resources based on a DL beam. For example, all UEs in the first group 1010 (G1) may monitor or receive LP-WUS transmitted using DL beam 1011 in time resources labeled as “LP-WUS MO for G1” and all UEs in the second group 1020 (G2) may monitor or receive LP-WUS transmitted using DL beam 1021 in time resources labeled as “LP-WUS MO for G2”. As an example, the UE 1012 may monitor LP-WUS in LP-WUS monitoring occasions for the first group 1010 (G1) to check whether it's in range or out of range of LP-WUS transmitted using DL beam 1011. In some aspects, for each LP-WUS resource, the network may transmit a LP-WUS targeted for a UE in the respective group or a LP-WUS with no target.

In some aspects, time and frequency resources of LP-WUS are based on the TCI state (i.e., DL beam) of the LP-WUS. In some aspects, LP-WUS resources are based on QCL'ed reference signal of the LP-WUS. In some aspects, LP-WUS resources (or resources for PDCCH monitoring triggered by LP-WUS) may be configured using periodicity and offset, and periodicity and offset may be based on TCI state of the LP-WUS or QCL'ed RS of the LP-WUS. In some aspects, the offset may be time (or frequency) offset from SSB resources. In some aspects, the network may inform (e.g., by transmitting a configuration) UE(s) with the association between LP-WUS time/frequency resources and SSBs that are QCL'ed with LP-WUS that are transmitted in those resources. The UEs may be accordingly aware of resources in which the LP-WUS is transmitted, and the DL beam associated with the resources used to carry the LP-WUS (e.g., because information regarding LP-WUS indicating which resource is QCL'ed with which SSB may be provided). In some aspects, if a UE receives TCI activation message for LP-WUS, the UE may calculate the resource for LP-WUS based on the activated TCI state and the association between TCI state and LP-WUS resource. The TCI activation indication may be included in the LP-WUS. The UE may monitor for LP-WUS corresponding to TCI states that are not activated for UE (i.e., UE monitors for LP-WUS that are transmitted on DL beams that the UE is not actively monitoring for its LP-WUS) based on the association of LP-WUS resource and TCI states. The monitoring of LP-WUS corresponding to deactivated TCI states may be part of UE's beam failure detection/recovery procedure. Association of LP-WUS resource and TCI states may be able to let the UE be aware of in which resources the network transmits LP-WUS on other DL beams. For example, as illustrated in FIG. 10, the UE 1012 may be originally at a location 1012B. The UE 1012 may be able to know that it's currently associated with the first beam 1011 based on being able to receive LP-WUS for G1 and unable to receive LP-WUS for G2. As the UE 1012 moves to a location 1012A that may be outside a coverage area for the first beam 1011, the UE 1012 may no longer be able to receive LP-WUS for G1. As the UE 1012 moves to a location 1012C that may be inside a coverage area for the second beam 1021 but outside a coverage area for the first beam 1011, the UE 1012 may be able to receive LP-WUS for G2 and unable to receive LP-WUS for G1. Therefore, the UE 1012 may be able to know in which resource LP-WUS corresponding to a different beam is transmitted. The UE 1012 may transmit an indication of the TCI state associated with the second beam 1021 to inform the network that it has moved.

Table 2 below is an example association between LP-WUS and resources:

TABLE 2
Example association between LP-WUS and resources

| | TCI 1, QCL'ed | TCI 2, QCL'ed | TCI 3, QCL'ed | TCI 4, QCL'ed |
|---|---|---|---|---|
| | RS = SSB1 | RS = SSB2 | RS = SSB3 | RS = SSB4 |
| LP-WUS offset | 10 slots, offset | 10 slots, offset | 10 slots, offset | 10 slots, offset |
| | from SSB1 resource | from SSB2 resource | from SSB3 resource | from SSB4 resource |
| LP-WUS periodicity | 10, 20, 30 ms | 10, 20, 30 ms | 10, 20, 30 ms | 10, 20, 30 ms |

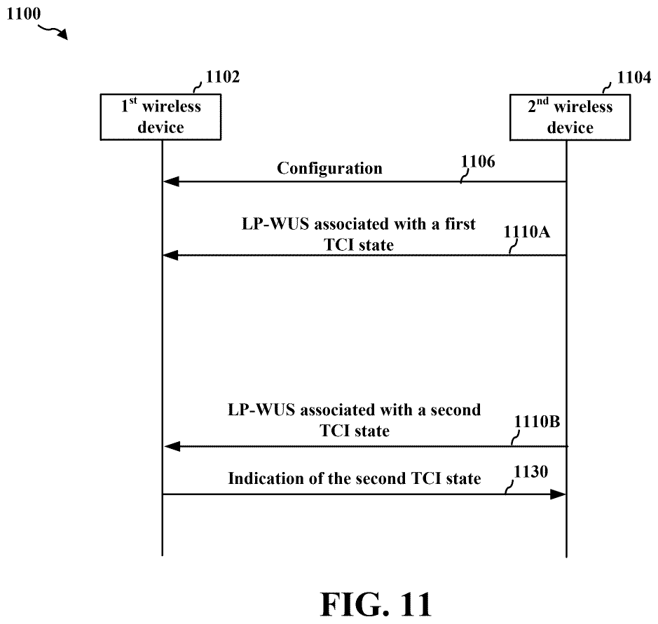

FIG. 11 is a diagram 1100 illustrating example communications between a UE (the first wireless device 1102) and a network node (the second wireless device 1104), in accordance with various aspects of the present disclosure. As illustrated in FIG. 11, the first wireless device 1102 may receive a configuration 1106 from the second wireless device 1104. The configuration 1106 may configure association between LP-WUS TCI state or DL beam and resources in which the LP-WUS is transmitted, and may also configure LP-WUS monitoring occasion(s) for different beams. The first wireless device 1102 may be able to receive a first LP-WUS 1110A associated with a first TCI state. In some aspects, the first TCI state may correspond to the first beam 1011. In some aspects, at a later time, first wireless device 1102 may be able to receive a second LP-WUS 1110B associated with a second TCI state. In some aspects, the second TCI state may correspond to the second beam 1021. Based on reception of the second LP-WUS 1110B, the first wireless device 1102 may be able to determine that it has moved outside of the range for the first beam 1011 and moved inside the range of the second beam 1021, and may transmit an indication 1130 accordingly.

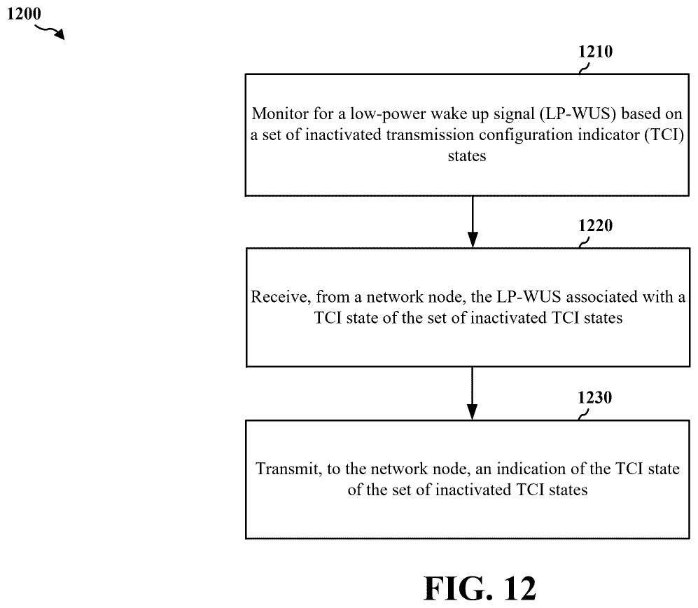

FIG. 12 is a flowchart 1200 of a method of wireless communication. The method may be performed by a UE (e.g., the UE 104, the UE 1012, the first wireless device 1102; the apparatus 1404). The method may enable the UE to determine a suitable downlink beam associated with the UE based on monitoring of a LP-WUS, which may improve communication performance. The method may enable the UE to check whether the UE is in the range of a LP-WUS associated with a TCI state or a DL beam of the network by associating different time/frequency resources for LP-WUS based on DL beam or TCI state.

At 1210, the UE may monitor for a LP-WUS based on a set of inactivated TCI states. For example, the UE (e.g., 1102) may monitor for a LP-WUS (e.g., 1110B) based on a set of inactivated TCI states. In some aspects, 1210 may be performed by LP-WUS component 198.

At 1220, the UE may receive, from a network node, the LP-WUS associated with a TCI state of the set of inactivated TCI states. For example, the UE (e.g., 1102) may receive, from a network node, the LP-WUS (e.g., 1110B) associated with a TCI state of the set of inactivated TCI states. In some aspects, 1220 may be performed by LP-WUS component 198.

At 1230, the UE may transmit, to the network node, an indication of the TCI state of the set of inactivated TCI states. For example, the UE (e.g., 1102) may transmit, to the network node (e.g., 1104), an indication (e.g., 1130) of the TCI state of the set of inactivated TCI states. In some aspects, 1230 may be performed by LP-WUS component 198.

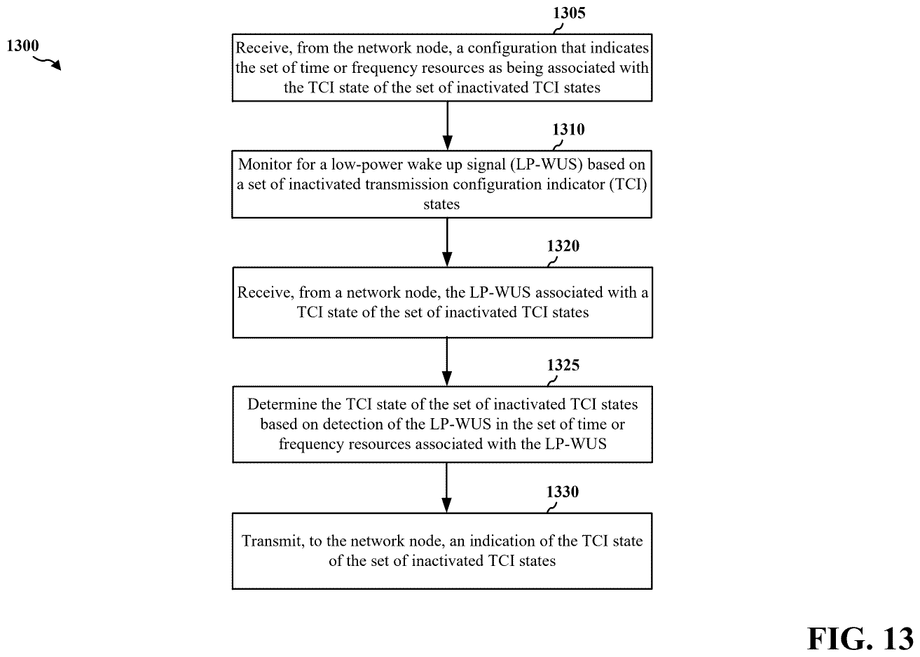

FIG. 13 is a flowchart 1300 of a method of wireless communication. The method may be performed by a UE (e.g., the UE 104, the UE 1012, the first wireless device 1102; the apparatus 1404). The method may enable the UE to determine a suitable downlink beam associated with the UE based on monitoring of a LP-WUS, which may improve communication performance. The method may enable a UE to check whether it's in the range of a LP-WUS associated with TCI state or DL beam of the network by associating different time/frequency resources for LP-WUS based on DL beam or TCI state of the LP-WUS.

At 1305, the UE may receive, from the network node, a configuration that indicates the set of time or frequency resources for LP-WUS as being associated with the TCI state of the set of inactivated TCI states. For example, the UE (e.g., 1102) may receive, from the network node, a configuration (e.g., 1106) that indicates the set of time or frequency resources for LP-WUS as being associated with the TCI state of the set of inactivated TCI states. In some aspects, 1305 may be performed by LP-WUS component 198.

At 1310, the UE may monitor for a LP-WUS based on a set of inactivated TCI states. For example, the UE (e.g., 1102) may monitor for a LP-WUS (e.g., 1110B) based on a set of inactivated TCI states. In some aspects, 1310 may be performed by LP-WUS component 198. In some aspects, a set of time or frequency resources associated with the LP-WUS is based on the TCI state of the set of inactivated TCI states.

At 1320, the UE may receive, from a network node, the LP-WUS associated with a TCI state of the set of inactivated TCI states. For example, the UE (e.g., 1102) may receive, from a network node, the LP-WUS (e.g., 1110B) associated with a TCI state of the set of inactivated TCI states. In some aspects, 1320 may be performed by LP-WUS component 198.

At 1325, the UE may determine the TCI state of the set of inactivated TCI states based on detection of the LP-WUS in the set of time or frequency resources for the LP-WUS associated with the TCI state. For example, the UE (e.g., 1102) may determine the TCI state of the set of inactivated TCI states based on detection of the LP-WUS in the set of time or frequency resources associated with the LP-WUS. In some aspects, 1325 may be performed by LP-WUS component 198.

In some aspects, the TCI state of the set of time or frequency resources associated with the LP-WUS is quasi-colocated (QCL'ed) with at least one reference signal, and where the configuration further includes quasi-colocation (QCL) information associated with the at least one reference signal. In some aspects, the configuration further indicates, for each TCI state of the set of inactivated TCI states, a respective set of time or frequency resources and at least one respective reference signal associated with the respective set of time or frequency resources of LP-WUS. In some aspects, the at least one respective reference signal corresponds to at least one synchronization signal block (SSB). In some aspects, the LP-WUS further includes an activation indication associated with the TCI state.

At 1330, the UE may transmit, to the network node, an indication of the TCI state of the set of inactivated TCI states. For example, the UE (e.g., 1102) may transmit, to the network node (e.g., 1104), an indication (e.g., 1130) of the TCI state of the set of inactivated TCI states. In some aspects, 1330 may be performed by LP-WUS component 198.

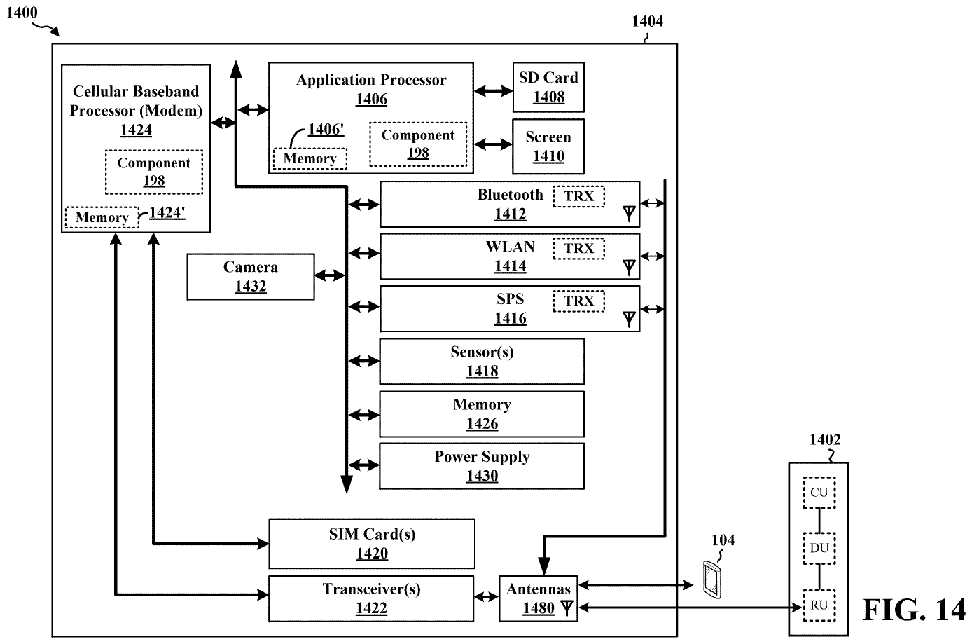

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the LP-WUS component 198 may be configured to monitor for a LP-WUS based on a set of inactivated transmission configuration indicator (TCI) states. In some aspects, the LP-WUS component 198 may be further configured to receive, from a network node, the LP-WUS associated with a TCI state of the set of inactivated TCI states. In some aspects, the LP-WUS component 198 may be further configured to transmit, to the network node, an indication of the TCI state of the set of inactivated TCI states. The LP-WUS component and/or the apparatus may be further configured to perform any of the aspects described in connection with the flowcharts in FIG. 12 and/or FIG. 13 and/or any of the aspects performed by the first wireless device 1102 in FIG. 11. The LP-WUS component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for monitoring for a LP-WUS based on a set of inactivated TCI states. In some aspects, the apparatus 1404 may include means for receiving, from a network node, the LP-WUS associated with a TCI state of the set of inactivated TCI states. In some aspects, the apparatus 1404 may include means for transmitting, to the network node, an indication of the TCI state of the set of inactivated TCI states. In some aspects, the apparatus 1404 may include means for receiving, from the network node, a configuration that indicates the set of time or frequency resources as being associated with the TCI state of the set of inactivated TCI states. In some aspects, the apparatus 1404 may include means for determining the TCI state of the set of inactivated TCI states based on detection of the LP-WUS in the set of time or frequency resources associated with the LP-WUS. The means may be the component 198 of the apparatus 1404 configured to perform the functions recited by the means. The apparatus may further include means for performing any of the aspects described in connection with the flowcharts in FIG. 12 and/or FIG. 13 and/or any of the aspects performed by the first wireless device 1102 in FIG. 11. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

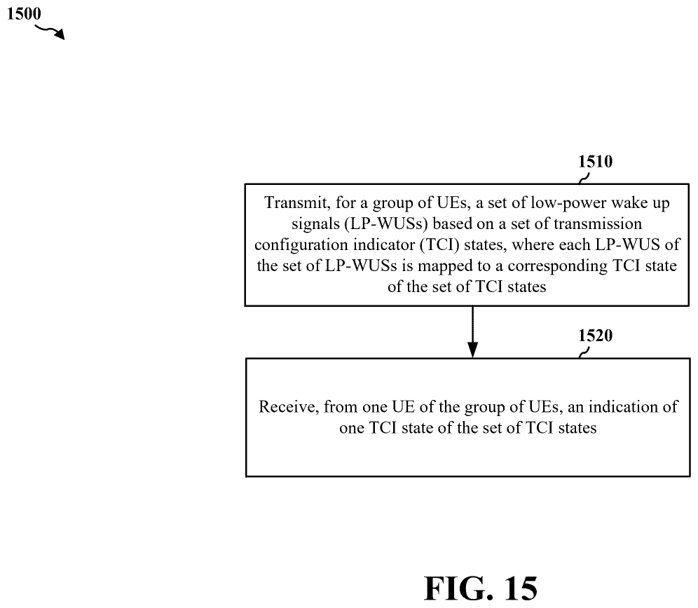

FIG. 15 is a flowchart 1500 of a method of wireless communication. The method may be performed by a network node (e.g., the base station 102, the second wireless device 1104, the network entity 1402, the network entity 1602).

At 1510, the network node may transmit, for a group of UEs, a set of LP-WUSs based on a set of TCI states, where each LP-WUS of the set of LP-WUSs is mapped to a corresponding TCI state of the set of TCI states. For example, the network node may transmit, for a group of UEs, a set of LP-WUSs (e.g., 1110A and 1110B) based on a set of TCI states, where each LP-WUS of the set of LP-WUSs is mapped to a corresponding TCI state of the set of TCI states. In some aspects, 1510 may be performed by LP-WUS component 199.

At 1520, the network node may receive, from one UE of the group of UEs, an indication of one TCI state of the set of TCI states. For example, the network node may receive, from one UE of the group of UEs, an indication (e.g., 1130) of one TCI state of the set of TCI states. In some aspects, 1520 may be performed by LP-WUS component 199. In some aspects, each LP-WUS of the set of LP-WUSs is associated with a respective set of time and frequency resources, and where the respective set of time and frequency resources is different for each LP-WUS. In some aspects, the indication of the one TCI state is based on a usage of the respective set of time and frequency resources associated with a LP-WUS mapped to the one TCI state. In some aspects, the network node may transmit a configuration (e.g., 1106) that indicates an association between the respective set of time or frequency resources and each LP-WUS of the set of LP-WUSs. In some aspects, a periodicity and an offset associated with each respective set of time and frequency resources is based on an associated LP-WUS for the respective set of time and frequency resources. In some aspects, at least one LP-WUS of the set of LP-WUSs is without a target UE. In some aspects, at least one LP-WUS of the set of LP-WUSs includes a TCI activation indication. In some aspects, the set of TCI states correspond to all DL spatial filters associated with the network node.

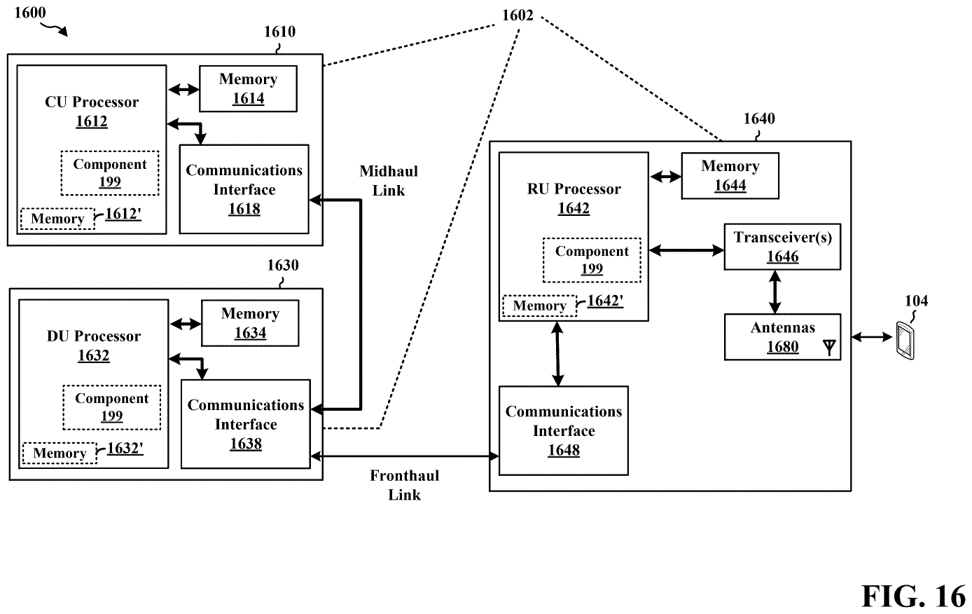

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LP-WUS component 199 may be configured to transmit, for a group of UEs, a set of LP-WUSs based on a set of TCI states, where each LP-WUS of the set of LP-WUSs is mapped to a corresponding TCI state of the set of TCI states. In some aspects, the LP-WUS component 199 may be further configured to receive, from one UE of the group of UEs, an indication of one TCI state of the set of TCI states. The LP-WUS component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, for a group of UEs, a set of LP-WUSs based on a set of TCI states, where each LP-WUS of the set of LP-WUSs is mapped to a corresponding TCI state of the set of TCI states. In some aspects, the network entity 1602 may include means for receiving, from one UE of the group of UEs, an indication of one TCI state of the set of TCI states. In some aspects, the network entity 1602 may include means for transmitting a configuration that indicates an association between the respective set of time or frequency resources and each LP-WUS of the set of LP-WUSs. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means. The apparatus may further include means for performing any of the aspects described in connection with the flowcharts in FIG. 15 any of the aspects performed by the second wireless device 1104 in FIG. 11.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to: monitor for a low-power wake up signal (LP-WUS) based on a set of inactivated transmission configuration indicator (TCI) states; receive, from a network node, the LP-WUS associated with a TCI state of the set of inactivated TCI states; and transmit, to the network node, an indication of the TCI state of the set of inactivated TCI states.

Aspect 2 is the apparatus of aspect 1, where a set of time or frequency resources associated with the LP-WUS is based on the TCI state of the set of inactivated TCI states.

Aspect 3 is the apparatus of aspect 2, where the at least one processor is configured to: receive, from the network node, a configuration that indicates the set of time or frequency resources as being associated with the TCI state of the set of inactivated TCI states.

Aspect 4 is the apparatus of aspect 3, where the at least one processor is configured to: determine the TCI state of the set of inactivated TCI states based on detection of the LP-WUS in the set of time or frequency resources associated with the LP-WUS.

Aspect 5 is the apparatus of any of aspects 3-4, where the set of time or frequency resources associated with the LP-WUS is quasi-colocated (QCL'ed) with at least one reference signal associated with the LP-WUS, and where the configuration further includes quasi-colocation (QCL) information associated with the at least one reference signal.

Aspect 6 is the apparatus of any of aspects 3-5, where the configuration further indicates, for each TCI state of the set of inactivated TCI states, a respective set of time or frequency resources and at least one respective reference signal associated with the respective set of time or frequency resources.

Aspect 7 is the apparatus of aspect 6, where the at least one respective reference signal corresponds to at least one synchronization signal block (SSB).

Aspect 8 is the apparatus of any of aspects 1-7, where the LP-WUS further includes an activation associated with the TCI state.

Aspect 9 is an apparatus for wireless communication at a network node, including: at least one memory; and at least one processor coupled to the at least one memory, based at least in part on information stored in the at least one memory, the at least one processor is configured to: transmit, for a group of UEs, a set of low-power wake up signals (LP-WUSs) based on a set of transmission configuration indicator (TCI) states, where each LP-WUS of the set of LP-WUSs is mapped to a corresponding TCI state of the set of TCI states; and receive, from one UE of the group of UEs, an indication of one TCI state of the set of TCI states.

Aspect 10 is the apparatus of aspect 9, where each LP-WUS of the set of LP-WUSs is associated with a respective set of time and frequency resources, and where the respective set of time and frequency resources is different for each LP-WUS.

Aspect 11 is the apparatus of aspect 10, where the indication of the one TCI state is based on a usage of the respective set of time and frequency resources associated with a LP-WUS mapped to the one TCI state.

Aspect 12 is the apparatus of any of aspects 10-11, where the at least one processor is further configured to: transmit a configuration that indicates an association between the respective set of time or frequency resources and each LP-WUS of the set of LP-WUSs.

Aspect 13 is the apparatus of any of aspects 10-12, where a periodicity and an offset associated with each respective set of time and frequency resources is based on an associated LP-WUS for the respective set of time and frequency resources.

Aspect 14 is the apparatus of any of aspects 9-13, where at least one LP-WUS of the set of LP-WUSs is without a target UE.

Aspect 15 is the apparatus of any of aspects 9-14, where at least one LP-WUS of the set of LP-WUSs includes a TCI activation indication.

Aspect 16 is the apparatus of any of aspects 9-16, where the set of TCI states correspond to all downlink (DL) spatial filters associated with the network node.

Aspect 17 is a method of wireless communication for implementing any of aspects 1 to 8.

Aspect 18 is a computer-readable medium (e.g., a non-transitory computer-readable medium) storing computer executable code, the code when executed by at least one processor causes the at least one processor to implement any of aspects 1 to 8.

Aspect 19 is an apparatus comprising means for implementing any of aspects 1 to 8.

Aspect 20 is a method of wireless communication for implementing any of aspects 9 to 16.

Aspect 21 is a computer-readable medium (e.g., a non-transitory computer-readable medium) storing computer executable code, the code when executed by at least one processor causes the at least one processor to implement any of aspects 9 to 16.

Aspect 22 is an apparatus comprising means for implementing any of aspects 9 to 16.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
monitor for a low-power wake up signal (LP-WUS) based on a set of inactivated transmission configuration indicator (TCI) states;
receive, from a network node, the LP-WUS associated with a TCI state of the set of inactivated TCI states; and
transmit, to the network node, an indication of the TCI state of the set of inactivated TCI states.

2. The apparatus of claim 1, wherein a set of time or frequency resources associated with the LP-WUS is based on the TCI state of the set of inactivated TCI states.

3. The apparatus of claim 2, wherein the at least one processor is configured to:
receive, from the network node, a configuration that indicates the set of time or frequency resources as being associated with the TCI state of the set of inactivated TCI states.

4. The apparatus of claim 3, wherein the at least one processor is configured to:
determine the TCI state of the set of inactivated TCI states based on detection of the LP-WUS in the set of time or frequency resources associated with the LP-WUS.

5. The apparatus of claim 3, wherein the set of time or frequency resources associated with the LP-WUS is quasi-colocated (QCL'ed) with at least one reference signal associated with the LP-WUS, and wherein the configuration further comprises quasi-colocation (QCL) information associated with the at least one reference signal.

6. The apparatus of claim 3, wherein the configuration further indicates, for each TCI state of the set of inactivated TCI states, a respective set of time or frequency resources and at least one respective reference signal associated with the respective set of time or frequency resources.

7. The apparatus of claim 6, wherein the at least one respective reference signal corresponds to at least one synchronization signal block (SSB).

8. The apparatus of claim 1, wherein the LP-WUS further comprises an activation associated with the TCI state.

9. A method for wireless communication performed by a user equipment (UE), comprising:
monitoring for a low-power wake up signal (LP-WUS) based on a set of inactivated transmission configuration indicator (TCI) states;
receiving, from a network node, the LP-WUS associated with a TCI state of the set of inactivated TCI states; and
transmitting, to the network node, an indication of the TCI state of the set of inactivated TCI states.

10. The method of claim 9, wherein a set of time or frequency resources associated with the LP-WUS is based on the TCI state of the set of inactivated TCI states.

11. The method of claim 10, further comprising:
receiving, from the network node, a configuration that indicates the set of time or frequency resources as being associated with the TCI state of the set of inactivated TCI states.

12. The method of claim 11, further comprising:
determining the TCI state of the set of inactivated TCI states based on detection of the LP-WUS in the set of time or frequency resources associated with the LP-WUS.

13. An apparatus for wireless communication at a network node, comprising:
at least one memory; and
at least one processor coupled to the at least one memory, based at least in part on information stored in the at least one memory, the at least one processor is configured to:
transmit, for a group of user equipment (UEs), a set of low-power wake up signals (LP-WUSs) based on a set of transmission configuration indicator (TCI) states, wherein each LP-WUS of the set of LP-WUSs is mapped to a corresponding TCI state of the set of TCI states; and
receive, from one UE of the group of UEs, an indication of one TCI state of the set of TCI states.

14. The apparatus of claim 13, wherein each LP-WUS of the set of LP-WUSs is associated with a respective set of time and frequency resources, and wherein the respective set of time and frequency resources is different for each LP-WUS.

15. The apparatus of claim 14, wherein the indication of the one TCI state is based on a usage of the respective set of time and frequency resources associated with a LP-WUS mapped to the one TCI state.

16. The apparatus of claim 14, wherein the at least one processor is further configured to:
transmit a configuration that indicates an association between the respective set of time or frequency resources and each LP-WUS of the set of LP-WUSs.

17. The apparatus of claim 14, wherein a periodicity and an offset associated with each respective set of time and frequency resources is based on an associated LP-WUS for the respective set of time and frequency resources.

18. The apparatus of claim 13, wherein at least one LP-WUS of the set of LP-WUSs is without a target UE.

19. The apparatus of claim 13, wherein at least one LP-WUS of the set of LP-WUSs comprises a TCI activation indication.

20. The apparatus of claim 13, wherein the set of TCI states correspond to all downlink (DL) spatial filters associated with the network node.
